(19) United States
(12) Patent Application Publication
(10) Pub. No.: US 2015/0036212 A1
(43) Pub. Date: Feb. 5, 2015

(54) DISPLAY DEVICE AND METHOD FOR MANUFACTURING THEREOF

(71) Applicant: Samsung Display Co., Ltd., Yongin-City (KR)

(72) Inventors: Yong Cheol JEONG, Yongin-si (KR); Seung Jun YU, Suwon-si (KR); Sang-Myoung LEE, Seoul (KR); Sang Woo WHANGBO, Seoul (KR)

(21) Appl. No.: 14/321,938

(22) Filed: Jul. 2, 2014

(30) Foreign Application Priority Data
Aug. 2, 2013 (KR) 10-2013-0092056

(51) Int. Cl. G02B 27/22

(52) U.S. Cl. CPC G02B 27/2214
USPC 359/463; 216/18

(57) ABSTRACT

A method of manufacturing a display device includes forming a first signal line and a second signal line on a first substrate, forming a first insulating layer, forming a first electrode layer on the first insulating layer, forming a first electrode piece and a first lens electrode from the first electrode layer based on a first mask, forming a second insulating layer on the first electrode piece and the first lens electrode, defining a first contact hole exposing the first signal line based on a second mask, and defining a second contact hole exposing the second signal line on the second mask, forming a second electrode layer on the second insulating layer, forming a lower electrode from the second electrode layer based on the first mask, forming a third electrode layer on the second insulating layer, and forming an upper electrode and a second lens electrode.

This application claims priority to Korean Patent Application No. 10-2013-0092056 filed on Aug. 2, 2013, and all the benefits accruing therefrom under 35 U.S.C. §119, the entire contents of which are incorporated herein by reference.

### BACKGROUND

(a) Field

The invention relates to a display device and a method of manufacturing the same. More particularly, the invention relates to a display device for both two-dimensional and three-dimensional images and a method of manufacturing the same.

(b) Description of the Related Art

According to the development of display device technologies, a three-dimensional (“3D”) stereoscopic image display device is recently spotlighted and various 3D image display methods are researched.

One of the most generally used methods of implementing a stereoscopic image display is a method using a binocular display. The method using the binocular display displays an image to a left eye and an image to a right eye with the same display device and makes the two images incident to the left eye and the right eye of an observer, respectively. That is, by inputting the images viewed from different angles into both eyes, respectively, the observer can feel a 3D effect.

Methods of inputting the images into the left eye and the right eye of the observer, respectively, include a method using a barrier and a method using a lenticular lens corresponding to a type of cylindrical lens.

A stereoscopic image display device using the barrier in which a slit is defined and divides an image from the display device into a left eye image and a right eye image through the slit, so as to allow the divided images to enter the left eye and the right eye of the observer, respectively.

A stereoscopic image display device using the lens displays each of the left eye image and the right eye image and changes an optical path of an image from the stereoscopic image display device by using the lens, so as to divide the image into the left eye image and the right eye image.

During a process of switching a flat image display method to a stereoscopic image display method, an image display device for both the two-dimensional (“2D”) and 3D images is developed, and accordingly a switchable lens is developed.

The lens includes a plurality of electrodes, and the display device includes contact holes for supplying voltages to the electrodes.

### SUMMARY

In order to form electrodes and contact holes, a plurality of masks is required. Since cost of the mask is expensive, a method of reducing a number of times the mask is used is being conducted.

The invention has been made in an effort to provide a display device which can be economically produced through a reduction in the number of times a mask is used, and a method of manufacturing the same.

An exemplary embodiment of the invention provides a method of manufacturing a display device, the method including forming a first signal line and a second signal line on a first substrate, forming a first insulating layer which covers the first signal line and the second signal line, forming a first electrode layer on the first insulating layer, forming a first electrode piece and a first lens electrode from the first electrode layer based on a first mask, forming a second insulating layer on the first electrode piece and the first lens electrode, defining a first contact hole exposing the first signal line in the first insulating layer, the second insulating layer, and the first electrode piece based on a second mask and forming a second contact hole exposing the second signal line on the first insulating layer and the second insulating layer based on the second mask, defining a second electrode layer on the second insulating layer while covering the first signal line and the second signal line, forming a lower electrode from the second electrode layer based on the first mask, forming a third electrode layer on the second insulating layer while covering the lower electrode and the second signal line, and forming an upper electrode and a second lens electrode from the third electrode layer based on the first mask.

In an exemplary embodiment, the first lens electrode, the second lens electrode, the lower electrode, and the upper electrode may include a transparent conductor.

In an exemplary embodiment, the method may further include forming an intermediate electrode from the first electrode piece based on the second mask during the defining the first contact hole.

In an exemplary embodiment, the intermediate electrode may include a part which is exposed by the second insulating layer.

In an exemplary embodiment, the lower electrode may side-contact the exposed part of the intermediate electrode and the first signal line.

In an exemplary embodiment, the lower electrode and the upper electrode may be separated in a plan view.

In an exemplary embodiment, the first lens electrode and the second lens electrode may be separated in the plan view.

In an exemplary embodiment, a gap may be defined between the first lens electrode and the second lens electrode.

In an exemplary embodiment, a gap may be defined between the first lens electrode and the second lens electrode.

In an exemplary embodiment, the forming the first electrode piece and the first lens electrode from the first electrode layer based on the first mask may include forming a first photosensitive film on the first electrode layer and forming a first photosensitive film pattern by etching the first photosensitive film by using the first mask, and the first electrode piece and the first lens electrode by etching the first electrode layer by using the first photosensitive film pattern as a mask.

In an exemplary embodiment, the defining the first contact hole exposing the first signal line in the first insulating layer, the second insulating layer, and the first electrode piece based on the second mask and the defining the second contact hole exposing the second signal line in the first insulating layer and the second insulating layer based on the second mask may include forming a second photosensitive film on the second insulating layer and forming a second photosensitive film pattern by etching the second photosensitive film by using the second mask, and defining the first contact hole exposing the first signal line and defining the second contact hole exposing the second signal line by etching the second insulating layer, the first electrode piece, and the first insulating layer by using the second photosensitive film pattern as a mask.

In an exemplary embodiment, the forming the lower electrode from the second electrode layer based on the first mask may include forming a third photosensitive film on the second electrode layer, forming a third photosensitive film pattern by etching the third photosensitive film by using the first mask, and forming the lower electrode by etching the second electrode layer by using the third photosensitive film pattern as a mask.

In an exemplary embodiment, the forming the upper electrode and the second lens electrode from the third electrode layer based on the first mask may include forming a fourth photosensitive film on the third electrode layer and forming a fourth photosensitive film pattern by etching the fourth photosensitive film by using the first mask, and forming the upper electrode and the second lens electrode by etching the third electrode layer by using the fourth photosensitive film pattern as a mask.

In an exemplary embodiment, the first, second, and third photosensitive films may include one of a positive photoresist material and a negative photoresist material, and the fourth photosensitive film may include the other of the positive photoresist material and the negative photoresist material.

In an exemplary embodiment, parts the other of the positive photoresist material and the negative photoresist material that receive light may be etched and a part of the fourth photosensitive film that does not receive light may be etched.

In an exemplary embodiment, when the first, second, and third electrode layers are etched, a value of a width of the electrode left after the etching divided by a width of the electrode before the etching is performed may be smaller than about 0.5.

Another exemplary embodiment of the invention provides a display device including a driver configured to provide a voltage, a display panel configured to display an image, and a lens part which is configured to allow the image of the display panel to be recognized as a two-dimensional image or a three-dimensional (“3D”) image and includes a linear lens part including a first substrate, a first insulating layer disposed on the first substrate, a first lens electrode disposed on the first insulating layer, a second insulating layer formed to cover the first lens electrode, and a second lens electrode disposed on the second insulating layer, and a pad which is configured to supply the voltage provided by the driver to the linear lens part and includes a first signal line disposed on the first substrate, a second signal line disposed on the first substrate to be adjacent and parallel to the first signal line, an intermediate electrode disposed on the first signal line and the first substrate, a lower electrode which contacts the first signal line and the intermediate electrode, and an upper electrode which contacts the second signal line.

In an exemplary embodiment, the first lens electrode, the second lens electrode, the intermediate electrode, the lower electrode, and the upper electrode may include transparent conductor.

In an exemplary embodiment, the lens part may further include a second insulating layer disposed on the first insulating layer while covering the intermediate electrode.

In an exemplary embodiment, the intermediate electrode may include a part which is exposed by the second insulating layer.

In an exemplary embodiment, a first contact hole exposing the first signal line may be defined on the first insulating layer, the exposed part of the intermediate electrode, and the second insulating layer.

In an exemplary embodiment, a second contact hole exposing the second signal line may be defined on the first insulating layer and the second insulating layer.

In an exemplary embodiment, the lower electrode may side-contact the exposed part of the intermediate electrode and the first signal line.

In an exemplary embodiment, according to exemplary embodiments of the invention, it is possible to economically produce a display device by reducing the number of times a mask is used.

### BRIEF DESCRIPTION OF THE DRAWINGS

The above and other exemplary embodiments, advantages and features of this disclosure will become more apparent by describing in further detail exemplary embodiments thereof with reference to the accompanying drawings, in which:

FIGS. 1 and 2 illustrate a schematic structure of an exemplary embodiment of a display device according to the invention and a method of forming a two-dimensional (“2D”) image and a three-dimensional (“3D”) image;

FIG. 3 is a top plan view schematically illustrating an exemplary embodiment of a lens part according to the invention;

FIG. 4 is a cross-sectional view illustrating an exemplary embodiment of a linear lens part according to the invention;

FIG. 5 schematically illustrates to an exemplary embodiment of a linear lens part, a pad, and a driver according the invention;

FIG. 6 is a cross-sectional view taken along line I-I′ of an exemplary embodiment of a pad and taken along line II-II′ of a lens part according to the invention; and

FIGS. 7A to 22 are plan views in an intermediate operation of an exemplary embodiment of a method of manufacturing the linear lens part and the pad of FIG. 6 according to the invention.

### DETAILED DESCRIPTION

The invention will be described more fully hereinafter with reference to the accompanying drawings, in which exemplary embodiments of the invention are shown. As those skilled in the art would realize, the described embodiments may be modified in various different ways, all without departing from the spirit or scope of the invention.

In the drawings, the thickness of layers, films, panels, regions, etc., are exaggerated for clarity. Like reference numerals designate like elements throughout the specification. It will be understood that when an element such as a layer, film, region, or substrate is referred to as being “on” another element, it can be directly on the other element or intervening elements may also be present. In contrast, when an element is referred to as being “directly on” another element, there are no intervening elements present.

It will be understood that, although the terms “first,” “second,” “third” etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, “a first element,” “component,” “region,” “layer” or “section” discussed below could be termed a second element, component, region, layer or section without departing from the teachings herein.

The terminology used herein is for the purpose of describing particular embodiments only and is not intended to be limiting. As used herein, the singular forms “a,” “an,” and “the” are intended to include the plural forms, including “at least one,” unless the content clearly indicates otherwise. “Or” means “and/or.” As used herein, the term “and/or” includes any and all combinations of one or more of the associated listed items. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Furthermore, relative terms, such as “lower” or “bottom” and “upper” or “top,” may be used herein to describe one element's relationship to another element as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on “upper” sides of the other elements. The exemplary term “lower,” can therefore, encompasses both an orientation of “lower” and “upper,” depending on the particular orientation of the figure. Similarly, if the device in one of the figures is turned over, elements described as “below” or “beneath” other elements would then be oriented “above” the other elements. The exemplary terms “below” or “beneath” can, therefore, encompass both an orientation of above and below.

“About” or “approximately” as used herein is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” can mean within one or more standard deviations, or within ±30%, 20%, 10%, 5% of the stated value.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Exemplary embodiments are described herein with reference to cross section illustrations that are schematic illustrations of idealized embodiments. As such, variations from the shapes of the illustrations as a result, for example, of manufacturing techniques and/or tolerances, are to be expected. Thus, embodiments described herein should not be construed as limited to the particular shapes of regions as illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the present claims.

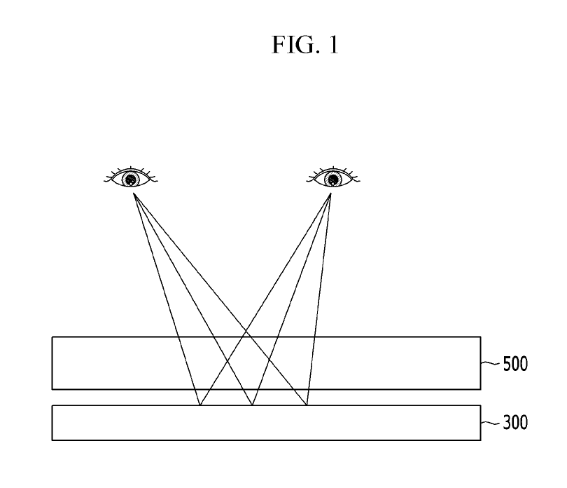

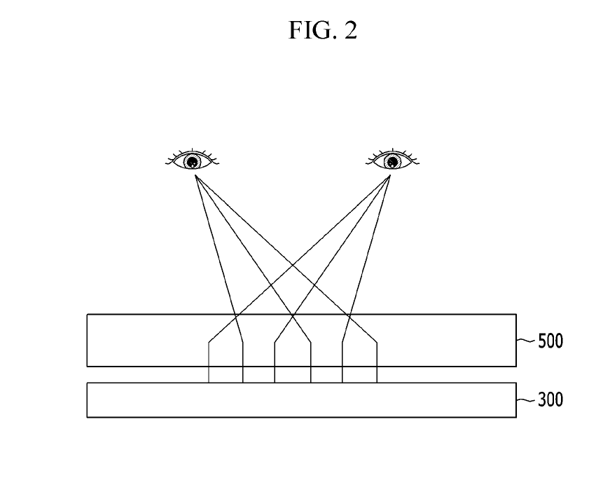

FIGS. 1 and 2 illustrate a schematic structure of an image display device according to an exemplary embodiment of the invention and a method of forming a two-dimensional (“2D”) image and a three-dimensional (“3D”) image.

Referring to FIGS. 1 and 2, an image display device according to an exemplary embodiment of the invention includes a display panel 300 displaying an image and a lens part 500 located in front of a surface displaying the image of the display panel 300.

The display panel 300 may be various flat panel displays such as a plasma display panel (“PDP”), a liquid crystal display (“LCD”) and an organic light emitting display (“OLED”), for example. The display panel 300 includes a plurality of pixels which is arranged in a matrix form and display an image. The display panel 300 displays one flat image in a 2D mode, but may alternately display images corresponding to various visual fields such as a right eye image and a left eye image in a space division scheme or a time division scheme in a 3D mode. In an exemplary embodiment, the display panel 300 may alternately display the right eye image and the left eye image at every one column pixel in the 3D mode, for example.

The lens part 500 can turn on/off a switch to separate visual fields of the image displayed on the display panel 300 by using a diffraction phenomenon of light. That is, the lens part 500 refracts the image of the display panel 300 by using the diffraction phenomenon of the light, so that the image is focused on a corresponding visual field. The lens part 500 is turned off when the display panel 300 is in the 2D mode, and is turned on when the display panel 300 is in the 3D mode, and thus serves to separate the visual fields of the image of the display panel 300. Alternatively, the lens part 500 may be turned off when the display panel 300 is in the 3D mode, and may be turned on when the display panel 300 is in the 2D mode.

FIG. 1 illustrates that the same image reaches a left eye and a right eye and thus a 2D image is recognized when the lens part 500 is turned off, and FIG. 2 illustrates that an image of the display panel 300 is separately refracted to each of visual fields such as a left eye and a right eye and thus a 3D image is recognized as the lens part 500 is turned on.

In an exemplary embodiment, the lens part 500 may be implemented by a Fresnel zone plate. In general, the Fresnel zone plate is radially arranged like a Fresnel zone, and refers to a device serving as a lens using a diffraction phenomenon of light instead of refraction of light through a plurality of concentric circles between which intervals become smaller from a center to an outside.

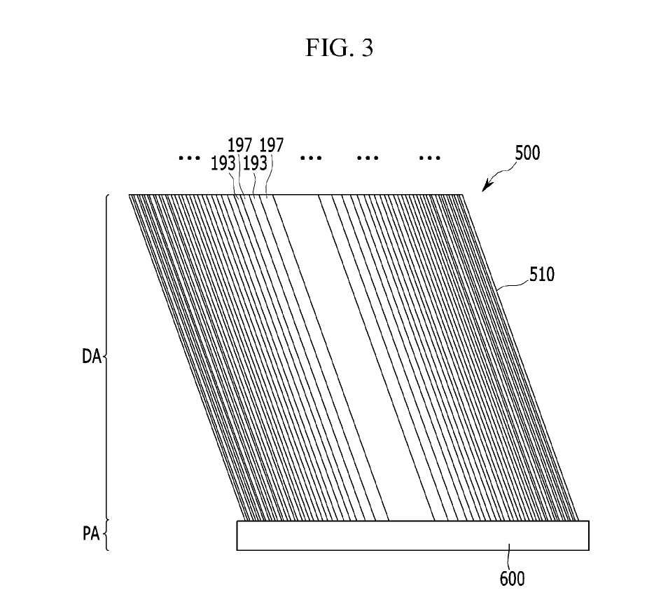

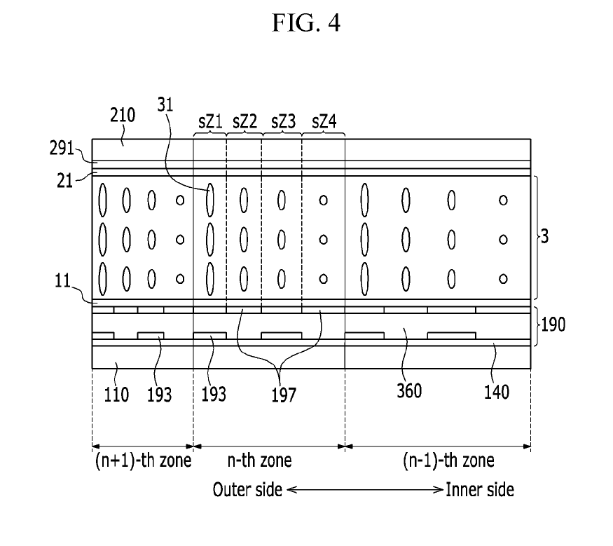

Subsequently, the lens part 500 according to an exemplary embodiment of the invention will be described with reference to FIGS. 3 and 4.

FIG. 3 is a top plan view schematically illustrating the lens part according to an exemplary embodiment of the invention.

The display device according to an exemplary embodiment of the invention includes a display area DA and a peripheral area PA. The lens part 500 according to the exemplary embodiment of the invention includes a linear lens part 510 and a pad 600.

The display area DA includes the linear lens part 510, and the area PA includes the pad 600. According to an exemplary embodiment of the invention, the linear lens part 510 and the pad 600 are connected to each other. The linear lens part 510 includes one or more first lens electrode 193 and one or more second lens electrode 197.

FIG. 4 is a cross-sectional view illustrating the linear lens part according to an exemplary embodiment of the invention.

A liquid crystal diffractive lens according to an exemplary embodiment of the invention includes a first substrate 110 and a second substrate 210 which face each other, and a liquid crystal layer 3 interposed between the two substrates 110 and 210. A first electrode layer 190 and an alignment layer 11 are sequentially disposed on the first substrate 110, and a common electrode 291 and an alignment layer 21 are sequentially disposed on the second substrate 210.

The first electrode layer 190 includes a plurality of first lens electrodes 193, a first insulating layer 140 on which the first lens electrodes 193 is disposed, a plurality of second lens electrodes 197 disposed on the first insulating layer 140, and a second insulating layer 360 covering the first lens electrodes 193, the first insulating layer 140, and the second lens electrodes 197. The first lens electrode 193 and the second lens electrode 197 may include a transparent conductive material such as indium tin oxide (“ITO”) or indium zinc oxide (“IZO”). However, the invention is not limited thereto, and the first lens electrode 193 and the second lens electrode 197 may include various other types of transparent conductive materials.

The first lens electrode 193 and the second lens electrode 197 are alternately located based on a first direction. The first direction is not parallel to a direction in which pixels are arranged in the display panel 300 and is oblique with respect to the direction of the arrangement of the pixels. Boundaries of the first lens electrode 193 and the second lens electrode 197 may match each other or be separated from each other on a plan view. In FIG. 4, although edges of the first lens electrode 193 and the second lens electrode 197 which neighbor each other are illustrated not to overlap each other, a part of the edges may slightly overlap each other.

When it is considered that a side where a center of one Fresnel zone plate is located is an inner side, horizontal widths of the first lens electrodes 193 and the second lens electrodes 197 or intervals between the first lens electrodes 193 and the second lens electrodes 197 gradually become smaller toward an outer side. The first lens electrodes 193 and the second lens electrodes 197 are elongated in an extension direction thereof, and the widths and intervals may be taken perpendicular to the extension direction.

The two lens electrodes including the first lens electrode 193 and the second lens electrode 197 are located in each zone of the zone plates such as an (n−1)-th zone, an n-th zone and an (n+1)-th zone, where n is a natural number, and an area where each of the electrodes 193 and 197 is located in each zone provides one sub zone sZ1, sZ2, sZ3, or sZ4. In one zone, sub zones from an outer side to an inner side sequentially correspond to sZ1, sZ2, sZ3, and sZ4. Although FIG. 4 illustrates that one zone includes four sub zones sZ1, sZ2, sZ3, and sZ4, the number of sub zones is not limited thereto. Unlike FIG. 4, the horizontal widths of the first lens electrodes 193 and the second lens electrodes 197 included in one zone may be constant and the horizontal widths of the electrodes 193 and 197 included in each zone may be reduced toward the outer zone.

In all zones, the horizontal widths of the first lens electrodes 193 and the second lens electrodes 197 may be larger than or equal to a cell gap of the liquid crystal layer 3 taken in the cross sectional direction as shown in FIG. 4. In an exemplary embodiment, the cell gap of the liquid crystal layer 3 may become smaller than or equal to about 10 micrometers (μm), and more specifically, become smaller than or equal to about 5 μm, so that it may be easy to control liquid crystal molecules 31, for example.

The first insulating layer 140 and the second insulating layer 360 may include an inorganic insulator or an organic insulator.

The common electrode 291 is disposed on an entire surface of the second substrate 210 and receives a predetermined voltage such as a common voltage. The common electrode 291 may include a transparent conductive material such as ITO or IZO, for example.

The alignment layers 11 and 21 may be rubbed in a length direction perpendicular to a width direction of the first lens electrode 193 and the second lens electrode 197 (i.e., a direction perpendicular to a surface of the drawing) or in a direction forming a predetermined angle with the width direction. In an exemplary embodiment, rubbing directions of the alignment layer 11 and the alignment layer 12 may be opposite to each other.

In an exemplary embodiment, liquid crystal molecules 31 of the liquid crystal layer 3 may be initially aligned in a direction parallel to surfaces of the substrates 110 and 210, but an alignment mode of the liquid crystal layer 3 is not limited thereto and can include a vertical alignment.

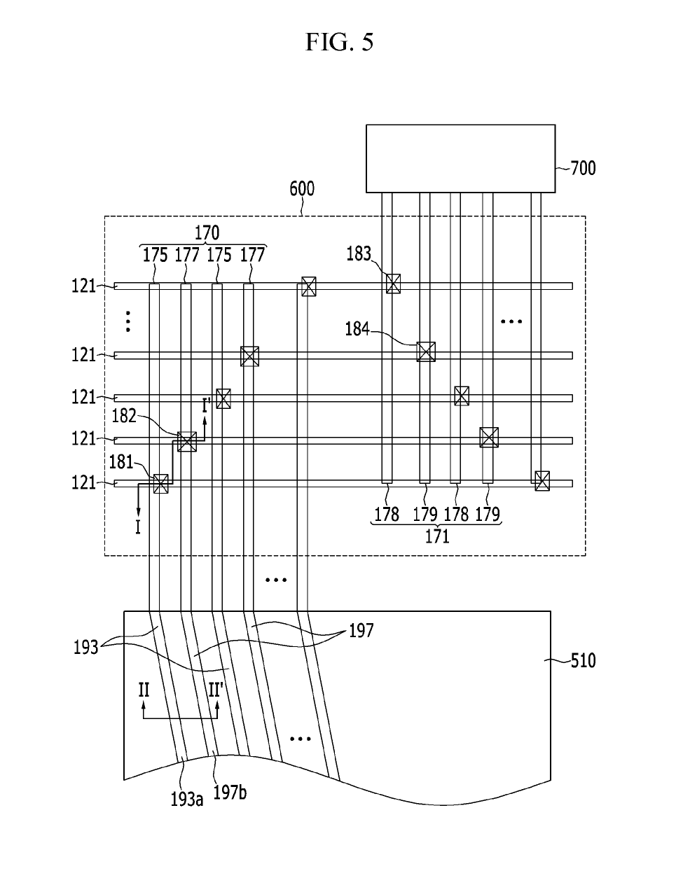

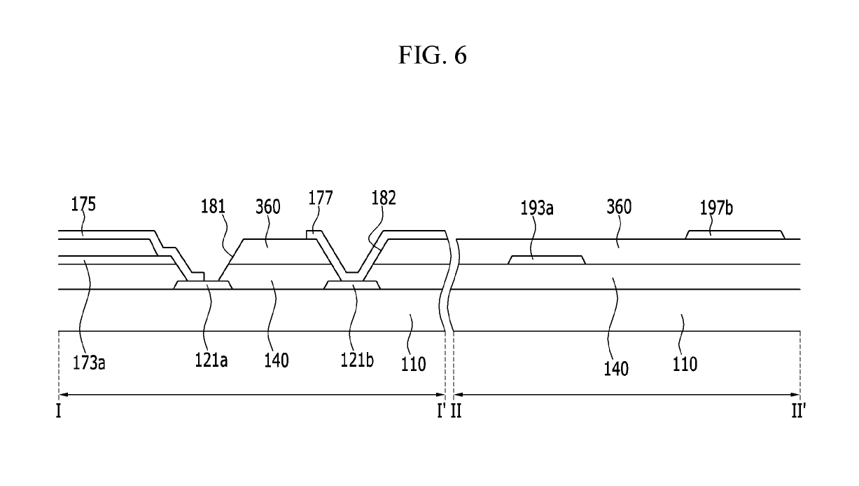

Subsequently, the pad according to an exemplary embodiment of the invention will be described with reference to FIGS. 5 and 6.

FIG. 5 schematically illustrates a linear lens part, a pad, and a driver within the lens part according to an exemplary embodiment of the invention.

FIG. 6 is a cross-sectional view taken along line I-I′ of the lens part and taken along line II-II′ of the lens part according to an exemplary embodiment of FIG. 5.

The pad 600 according to an exemplary embodiment of the invention includes a plurality of signal lines 121, a first pad electrode 170, a second pad electrode 171, a plurality of first contact holes 181, a plurality of second contact holes 182, a plurality of third contact holes 183, and a plurality of fourth contact holes 184.

The first pad electrode 170 includes a plurality of lower electrodes 175 and a plurality of upper electrodes 177.

The second pad electrode 171 includes a plurality of lower electrodes 178 and a plurality of upper electrodes 179.

According to an exemplary embodiment of the invention, the signal line 121 may be extended horizontally. At this time, the first pad electrode 170 and the second pad electrode 171 may be provided to be perpendicular to the signal line 121.

The lower electrode 175 is connected to the signal line 121 through the first contact hole 181. The upper electrode 177 is connected to the signal line 121 through the second contact hole 182.

The lower electrode 178 is connected to the signal line 121 through the third contact hole 183. The upper electrode 179 is connected to the signal line 121 through the fourth contact hole 184.

A driver 700 is connected to the pad 600 through the second pad electrode 171. The linear lens part 510 is connected to the pad 600 through the first pad electrode 170.

The driver 700 applies a voltage through the second pad electrode 171. A voltage applied to the second pad electrode 171 is applied to the first pad electrode 170 through the signal line 121. The voltage applied to the first pad electrode 170 is applied to the linear lens part 510.

More specifically, the voltage applied from the driver 700 is applied to the lower electrode 175 through the lower electrode 178 and the signal line 121. Further, the lower electrode 175 applies the voltage to the first lens electrode 193 of the linear lens part 510. That is, the lower electrode 178 of the second pad electrode 171 is connected to the lower electrode 175 of the first pad electrode 170 through the signal line 121.

The voltage applied from the driver 700 is applied to the upper electrode 177 through the upper electrode 179 and the signal line 121. Further, the upper electrode 177 applies the voltage to the second lens electrode 197 of the linear lens part 510. That is, the upper electrode 179 of the second pad electrode 171 is connected to the upper electrode 177 of the first pad electrode 170 through the signal line 121.

Referring to FIG. 6, a plurality of signal lines 121a and 121b is disposed on the first substrate 110 of the pad 600. In the illustrated exemplary embodiment, two signal lines 121a and 121b of the signal lines 121 neighboring each other will be described. However, the invention is not limited thereto, and different types of signal lines can be used. The first insulating layer 140 of the pad 600 covers the plurality signal lines 121a and 121b. The first insulating layer 140 of the lens part 500 is disposed on the first substrate 110.

An intermediate electrode 173a is disposed on the first insulating layer 140 of the pad 600. Further, one first lens electrode 193a (hereinafter, also referred to as a first lens electrode) of the plurality of first lens electrodes 193 is disposed on the first insulating layer 140 of the lens part 500. An end portion of the intermediate electrode 173a is exposed by the second insulating layer 360.

The second insulating layer 360 is disposed on the first insulating layer 140 while covering the intermediate electrode 173a and the first lens electrode 193a.

The first contact hole 181 exposing the signal line 121a is defined in the first insulating layer 140, the end of the intermediate electrode 173a and the second insulating layer 360.

The second contact hole 182 exposing the signal line 121b is defined in the first insulating layer 140 and the second insulating layer 360.

The first contact hole 181 and the second contact hole 182 are defined in the pad 600.

The lower electrode 175 is disposed on a part of the signal line 121a, an exposed part of the intermediate electrode 173a, the first insulating layer 140, the second insulating layer 360 and the first contact hole 181.

The intermediate electrode 173a side-contacts the signal line 121a through the lower electrode 175. Here, the side-contact between the intermediate electrode 173a and the signal line 121a through the lower electrode 175 means an electrical connection between the intermediate electrode 173a and the signal line 121a through the lower electrode 175.

The upper electrode 177 is disposed on the signal line 121b, the first insulating layer 140, the second insulating layer 360 and the second contact hole 182.

The lower electrode 175, the intermediate electrode 173a, and the upper electrode 177 are disposed in the pad 600. Further, the lower electrode 175, the intermediate electrode 173a, and the upper electrode 177 may include a transparent conductive material such as ITO or IZO, for example.

A second lens electrode 197b (hereinafter, referred to as a second lens electrode) adjacent to the first lens electrode 193a among the plurality of second lens electrodes is disposed on the second insulating layer 360.

The second lens electrode 197b is disposed on the lens part 500. The second lens electrode 197b and the first lens electrode 193a are alternately provided without overlapping.

The first lens electrode 193a and the second lens electrode 197b may include a transparent conductive material such as ITO or IZO, for example.

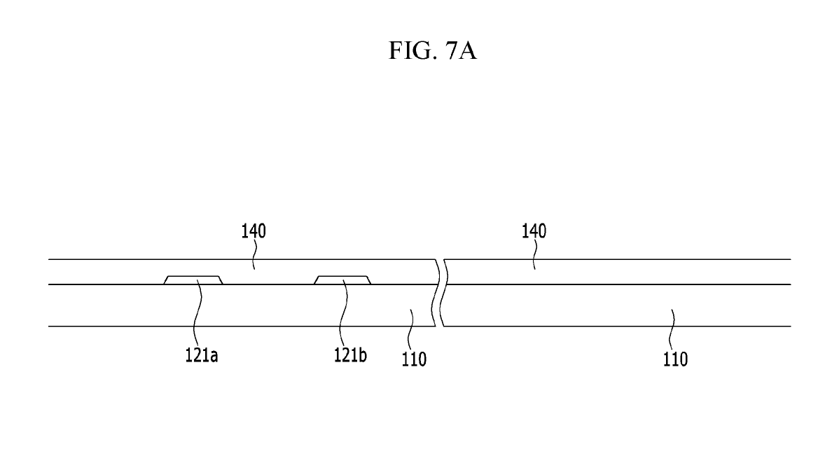

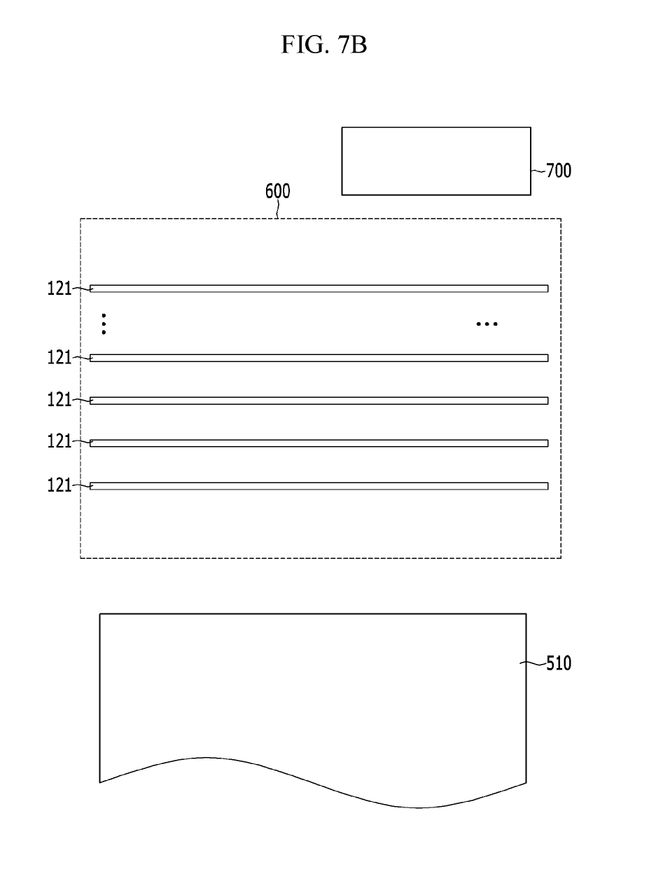

Subsequently, a method of forming the linear lens part and the pad of FIG. 6 according to an exemplary embodiment of the invention will be described with reference to FIGS. 7A to 22.

FIGS. 7A to 22 are plan views of an intermediate operation of a method of manufacturing the linear lens part and the pad of FIG. 6 according to an exemplary embodiment of the invention.

As illustrated in FIG. 7A, the signal lines 121a and 121b are disposed on the first substrate 110 of the pad 600. At this time, a mask may be used during a process of providing the signal lines 121a and 121b. Thereafter, the signal lines 121a and 121b are disposed on the first substrate 110, and the first insulating layer 140 is provided on the signal lines 121a and 121b.

FIG. 7B is a top plan view of FIG. 7A.

As illustrated in FIG. 7B, the plurality of signal lines 121 is disposed in the pad 600. The signal lines 121a and 121b correspond to two signal lines neighboring each other among the plurality of signal lines 121. At this time, the plurality of signal lines 121 may be provided in a horizontal direction. Further, each of the signal lines 121 may be parallel to each other.

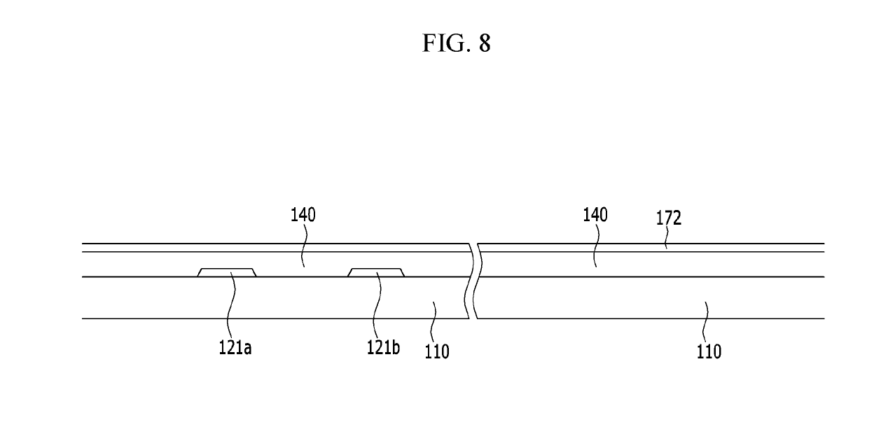

Thereafter, the first electrode layer 172 is disposed on the first insulating layer 140 as illustrated in FIG. 8. The first electrode layer 172 according to an exemplary embodiment of the invention may include a transparent conductive material such as ITO or IZO, for example.

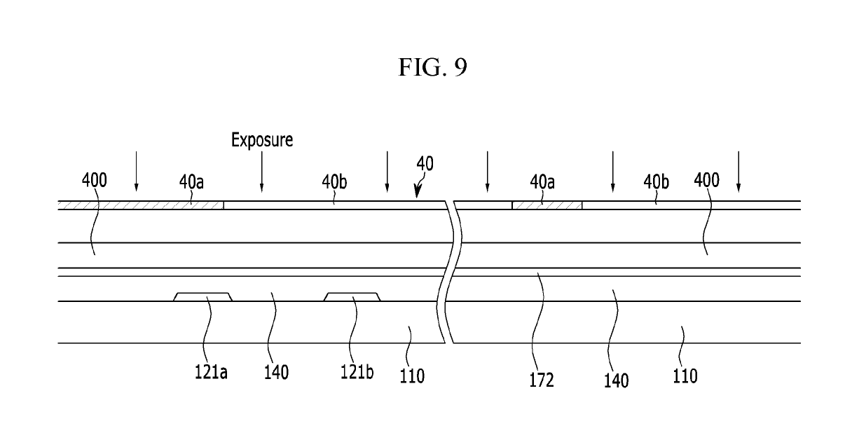

Thereafter, a first photosensitive film 400 is disposed on the first electrode layer 172 as illustrated in FIG. 9. Subsequently, an exposure is performed using the first mask 40. The first mask 40 according to an exemplary embodiment of the invention includes a light blocking part 40a and a light transmission part 40b. In the first photosensitive film 400 according to an exemplary embodiment of the invention, an area transmitting light is etched.

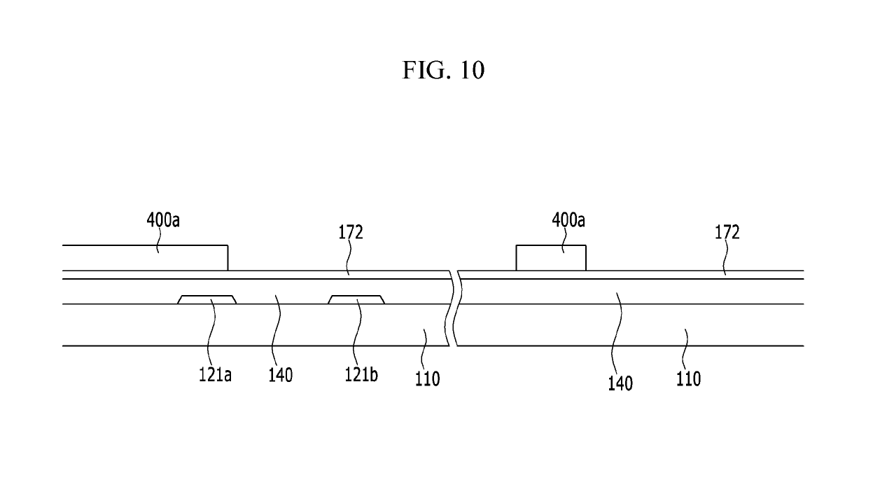

Thereafter, a first photosensitive film pattern 400a is provided as illustrated in FIG. 10. According to an exemplary embodiment of the invention, the first photosensitive film pattern 400a is disposed on each of the linear lens part 510 and the pad 600.

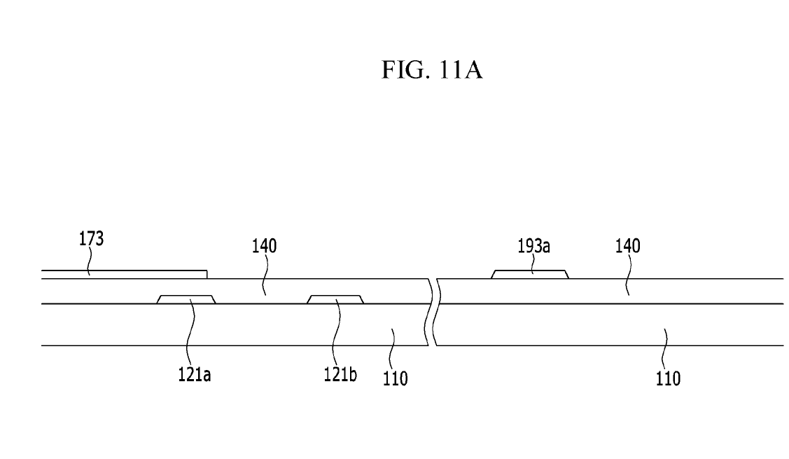

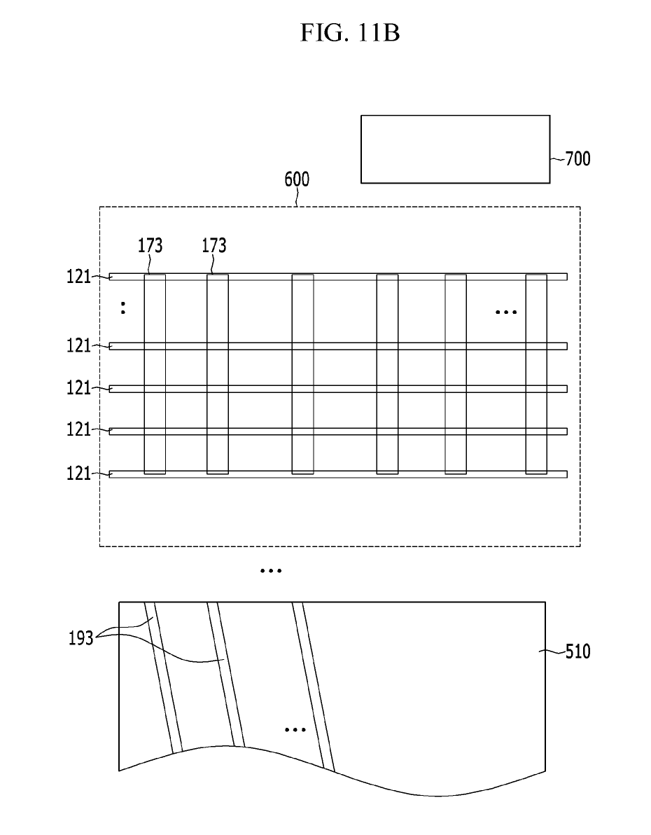

Subsequently, a first electrode piece 173 and the first lens electrode 193a are provided by using the first photosensitive film pattern 400a as the mask as illustrated in FIG. 11A. At this time, the first electrode piece 173 is disposed on the first insulating layer 140 of the pad 600, and the first lens electrode 193a is disposed on the first insulating layer 140 of the linear lens part 510. At this time, the first electrode piece 173 may be disposed on the signal line 121a.

FIG. 11B is a plan view of FIG. 11A.

As illustrated in FIG. 11B, the first electrode piece 173 may be disposed on the signal line 121. The first electrode piece 173 may be provided in a direction perpendicular to the signal line 121. Further, at this time, the first lens electrode 193a may be disposed in the linear lens part 510.

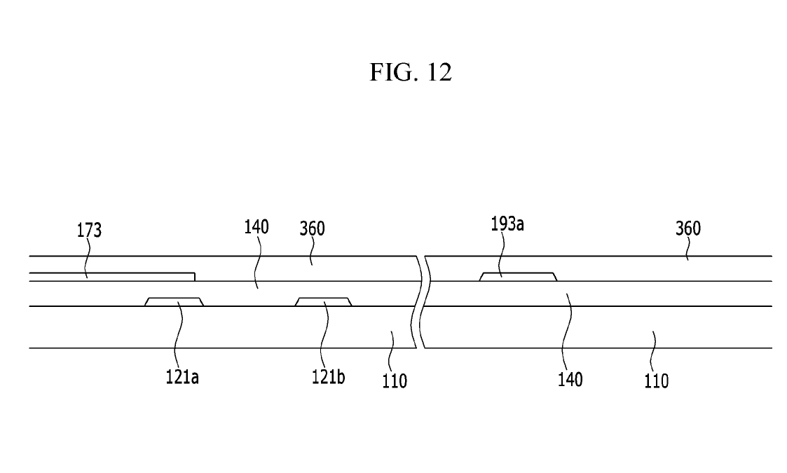

Thereafter, as illustrated in FIG. 12, the second insulating layer 360 is disposed on the first insulating layer 140 while covering the first electrode piece 173 and the first lens electrode 193a.

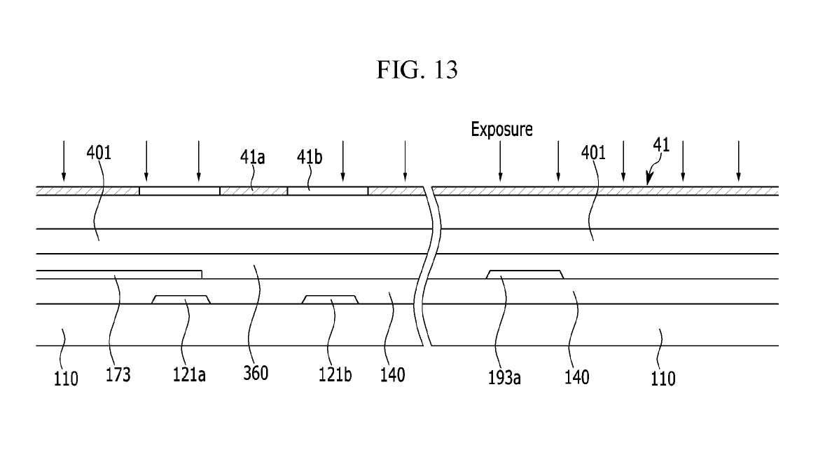

Subsequently, as illustrated in FIG. 13, a second photosensitive film 401 is disposed on the second insulating layer 360. Subsequently, an exposure is performed using a second mask 41. The second mask 41 according to an exemplary embodiment of the invention includes a light blocking part 41a and a light transmission part 41b. In the second photosensitive film 401 according to an exemplary embodiment of the invention, an area transmitting light is etched.

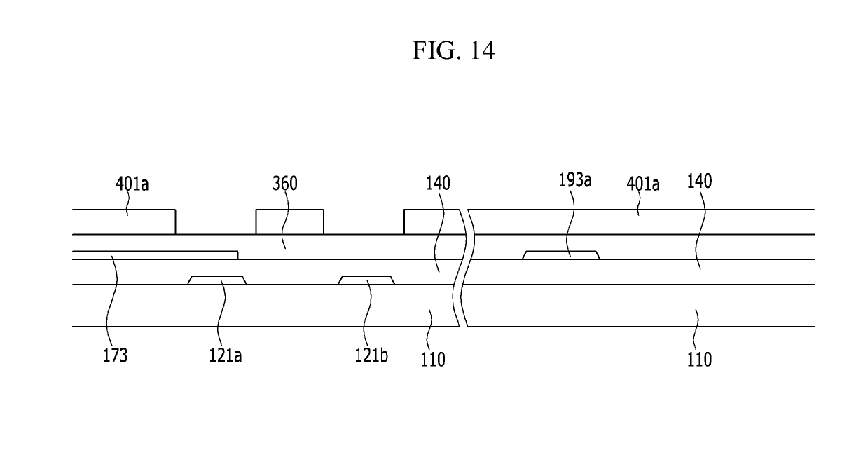

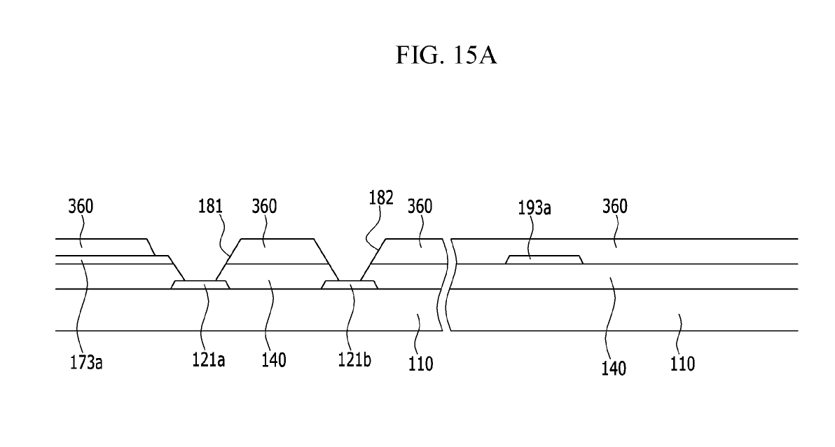

Thereafter, as illustrated in FIG. 14, a second photosensitive film 401a is disposed on the second insulating layer 360. According to an exemplary embodiment of the invention, each second photosensitive film pattern 401a is disposed in the pad 600. According to an exemplary embodiment of the invention, the second photosensitive film pattern 401a is provided not to overlap each of the signal line 121a and the signal line 121b.

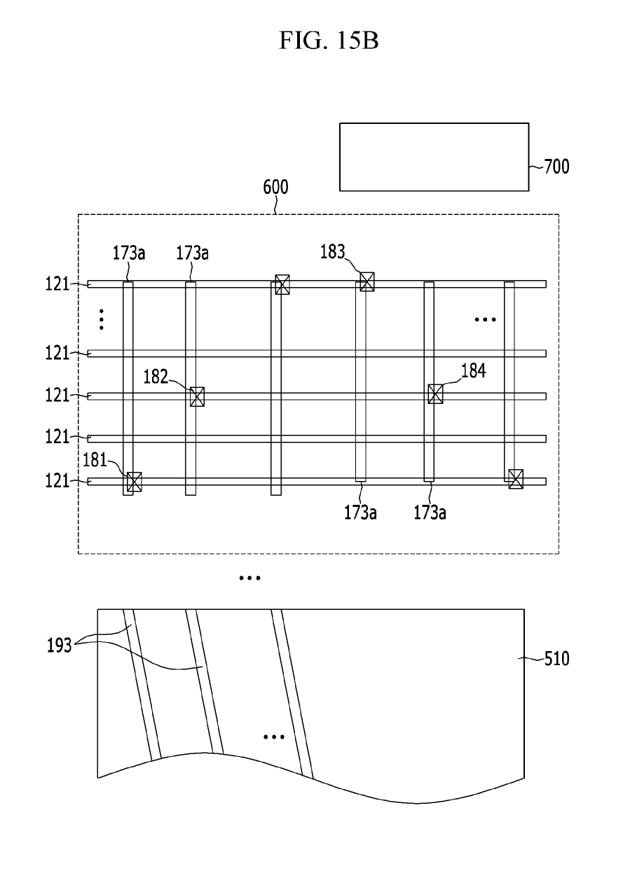

Thereafter, as illustrated in FIG. 15A, the first contact hole 181 and the second contact hole 182 are defined using each of the second photosensitive film patterns 401a as the mask.

At this time, the first contact hole 181 exposing the signal line 121a is defined in the first insulating layer 140, the end of the intermediate electrode 173a, and the second insulating layer 360, and the second contact hole 182 exposing the signal line 121b is defined in the first insulating layer 140 and the second insulating layer 360. The first contact hole 181 and the second contact hole 182 are defined in the pad 600. In the forming the first contact hole 181, the first electrode piece 173 is etched, and thus the intermediate electrode 173a is provided.

A process of defining the first contact hole 181 will be described in more detail. When the etching is performed, the first insulating layer 140 is less etched than the second insulating layer 360 by using the second photosensitive film pattern 401a on the signal line 121a as the mask. It is because the first electrode piece 173 is disposed on the first insulating layer 140. Since the first electrode piece 173 is less etched than the insulating layers 140 and 360 in the same condition, the first electrode piece 173 disturbs the etching of the first insulating layer 140. Accordingly, according to an exemplary embodiment of the invention, the second insulating layer 360 is the most etched, followed by the first electrode piece 173, and the first insulating layer is least etched. Therefore, a part of the first contact hole 181 may form a stepped shape.

During the process, the intermediate electrode 173a is provided by the first electrode piece 173 and a part of the intermediate electrode 173a is exposed. The exposed part of the intermediate electrode 173a according to an exemplary embodiment of the invention may be the end portion of the intermediate electrode 173a.

FIG. 15B is a top plan view of FIG. 15A.

As illustrated in FIG. 15B, during the process, the first and second contact holes 181 and 182, and third and fourth contact holes 183 and 184 are defined in the pad 600. Further, during a process of defining the first and third contact holes 181 and 183, the first electrode piece 173 is etched and the intermediate electrode 173a is provided.

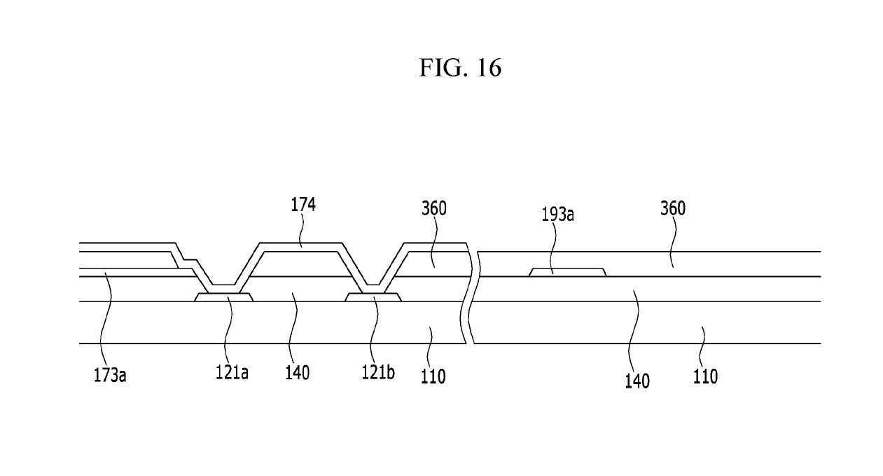

Thereafter, as illustrated in FIG. 16, a second electrode layer 174 covers the second insulating layer 360, the exposed part of the intermediate electrode 173a, and the signal lines 121a and 121b. At this time, the second electrode layer 174 is provided only in the pad 600. At this time, the second electrode layer 174 may include a transparent conductive material such as ITO or IZO, for example.

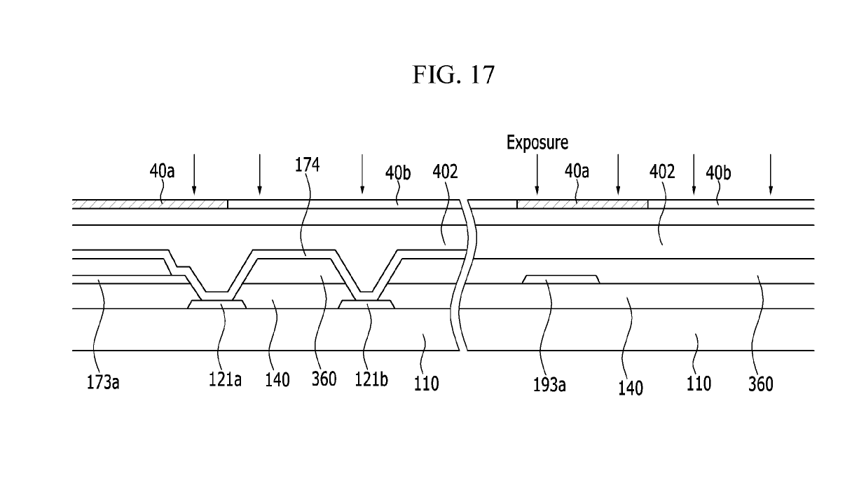

Thereafter, as illustrated in FIG. 17, a third photosensitive film 402 is disposed on the second electrode layer 174 and the second insulating layer 360 of the linear lens part 510. Subsequently, an exposure is performed using the first mask 40. The first mask 40 according to an exemplary embodiment of the invention includes the light blocking part 40a and the light transmission part 40b. In the third photosensitive film 402 according to an exemplary embodiment of the invention, an area receiving light is etched.

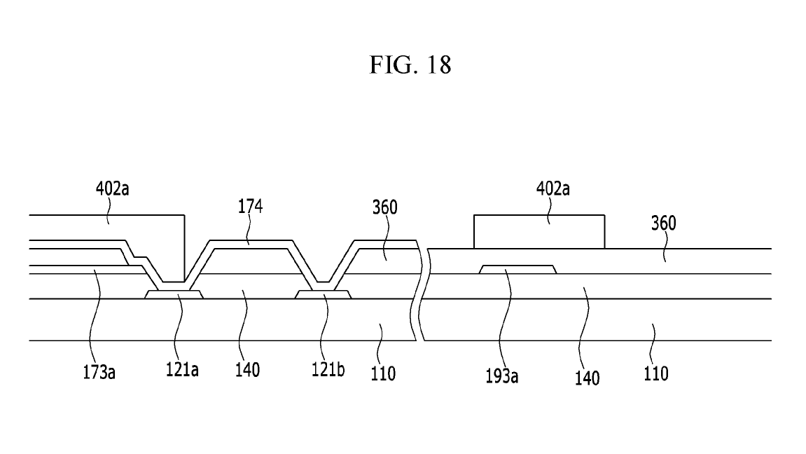

Thereafter, as illustrated in FIG. 18, the third photosensitive film pattern 402a is disposed on the second electrode layer 174. According to an exemplary embodiment of the invention, a third photosensitive film pattern 402a is provided on the signal line 121a. Further, according to an exemplary embodiment of the invention, the third photosensitive film pattern 402a may also be provided on the first lens electrode 193a of the linear lens part 510. At this time, the third photosensitive film pattern 402a may be provided directly on the second insulating layer 360 of the linear lens part 510.

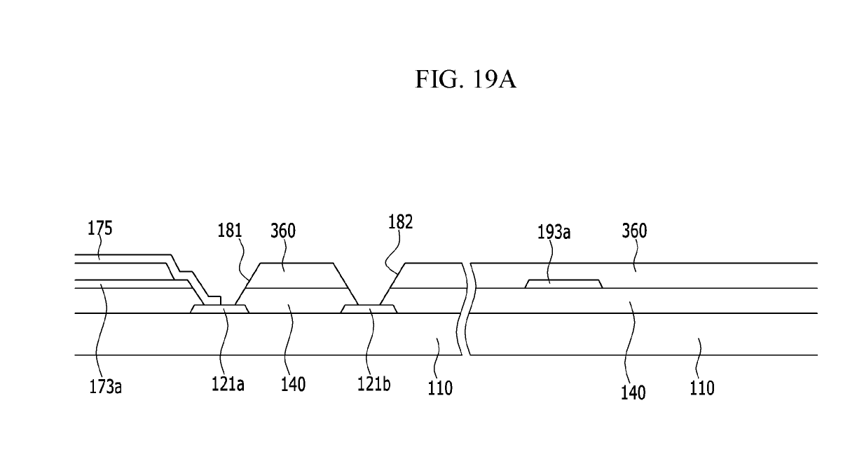

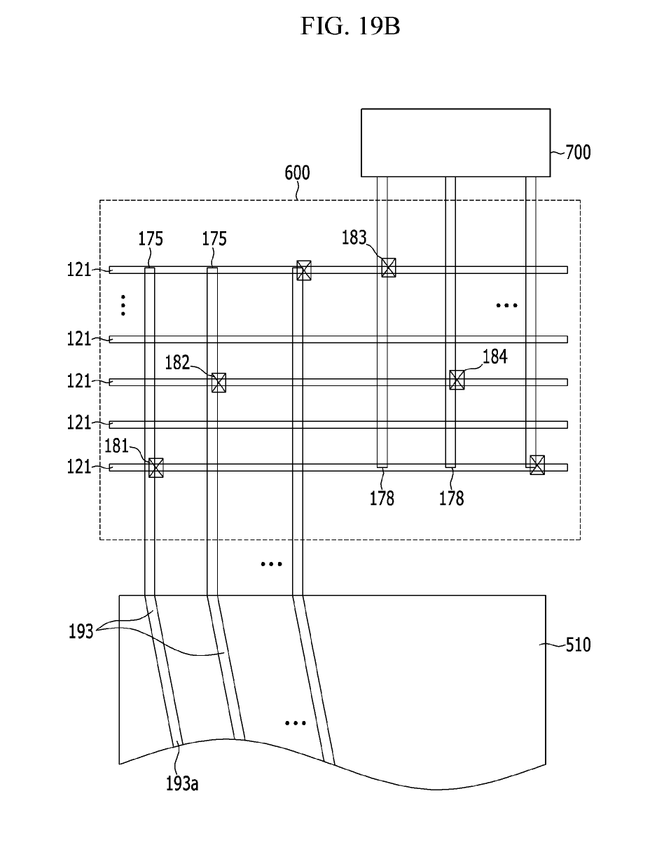

Thereafter, as illustrated in FIG. 19A, the lower electrode 175 is provided using the third photosensitive film pattern 402a as the mask. The lower electrode 175 is provided through a part of the signal line 121a, the exposed part of the intermediate electrode 173a, the first insulating layer 140, the second insulating layer 360, and the first contact hole 181. At this time, the intermediate electrode 173a side-contacts the signal line 121a through the lower electrode 175. During the process, in the linear lens part 510, only the third photosensitive film pattern 402a is etched without generating any layers.

FIG. 19B is a top plan view of FIG. 19A.

As illustrated in FIG. 19B, each of the lower electrodes 175 and 178 is disposed in the pad 600 during the process. Each of the lower electrodes 175 and 178 is disposed on the intermediate electrode 173a, such that the intermediate electrode 173a is not viewable in the plan view at this state.

At this time, the driver 700 is connected to the lower electrode 178 of the second pad electrode 171 disposed in the pad 600.

Further, at this time, the first lens electrode 193 disposed in the linear lens part 510 is connected to the lower electrode 175 of the first pad electrode 170 disposed in the pad 600.

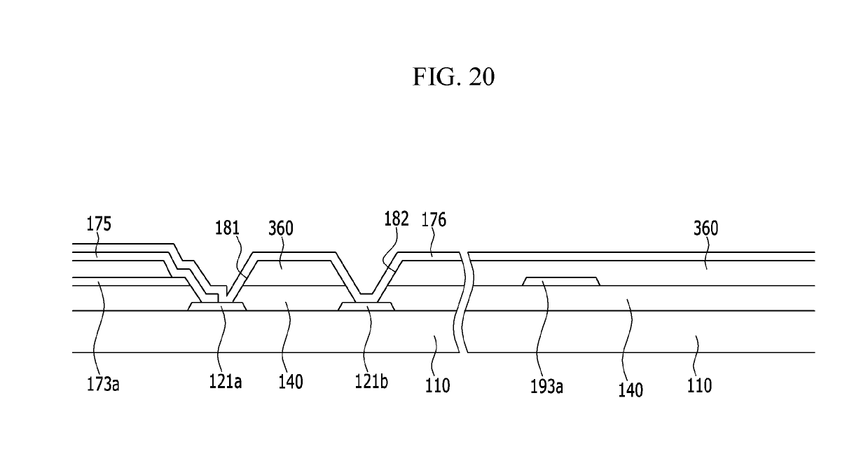

Thereafter, as illustrated in FIG. 20, a third electrode layer 176 covers the lower electrode 175, the second insulating layer 360, and the signal line 121b. The third electrode layer 176 according to an exemplary embodiment of the invention may include a transparent conductive material such as ITO or IZO, for example.

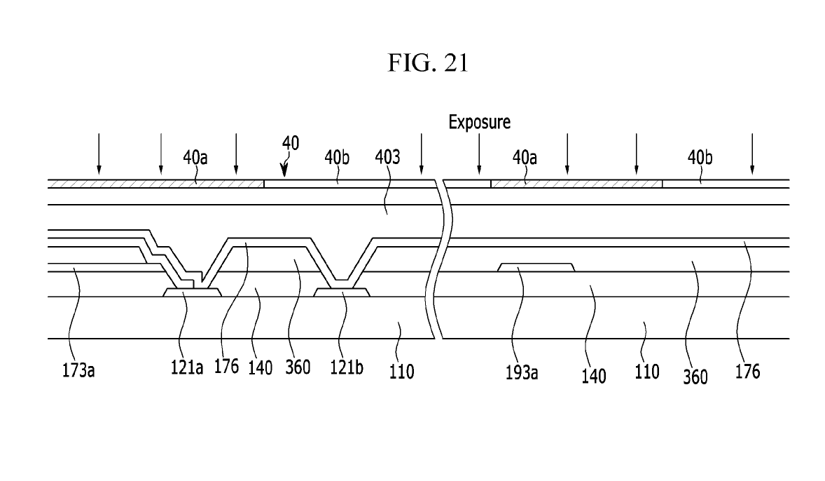

Thereafter, as illustrated in FIG. 21, a fourth photosensitive film 403 is disposed on the third electrode layer 176 and the second insulating layer 360 of the linear lens part 510. Subsequently, an exposure is performed using the first mask 40. The first mask 40 according to an exemplary embodiment of the invention includes the light blocking part 40a and the light transmission part 40b. In the fourth photosensitive film 403 according to an exemplary embodiment of the invention, an area transmitting light is etched.

In an exemplary embodiment, the first, second and third photosensitive films 400, 401 and 402 may include one of a positive photoresist material and a negative photoresist material, and the fourth photosensitive film 403 may include the other of the positive photoresist material and the negative photoresist material. A positive resist is a type of photoresist in which the portion of the photoresist that is exposed to light becomes soluble to the photoresist developer. The portion of the photoresist that is unexposed remains insoluble to the photoresist developer. A negative resist is a type of photoresist in which the portion of the photoresist that is exposed to light becomes insoluble to the photoresist developer. The unexposed portion of the photoresist is dissolved by the photoresist developer.

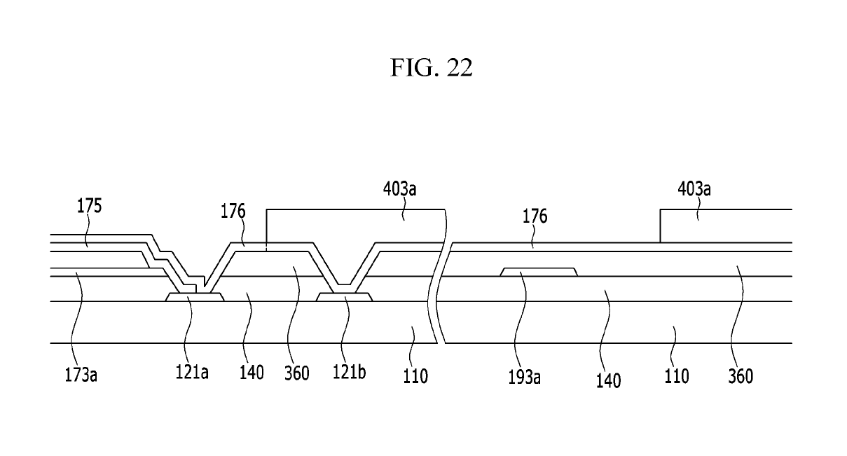

Thereafter, as illustrated in FIG. 22, a fourth photosensitive film pattern 403a is disposed on the third electrode layer 176. According to an exemplary embodiment of the invention, the fourth photosensitive film pattern 403a is disposed on the signal line 121b. Further, according to an exemplary embodiment of the invention, the fourth photosensitive film pattern 403a may be provided not to overlap the first lens electrode 193a of the linear lens part 510. That is, the fourth photosensitive film pattern 403a provided in the linear lens part 510 is not disposed on the first lens electrode 193a. That is, the fourth photosensitive film pattern 403a is provided not to overlap the positions where the first and third photosensitive film patterns 400a and 402a are provided.

Thereafter, the upper electrode 177 and the second lens electrode 197b are provided from the third electrode layer 176 using the fourth photosensitive film pattern 403a as the mask.

Referring back to FIG. 5, during the process, each of the upper electrodes 177 and 179 is disposed in the pad 600 and the second lens electrode 197b is disposed on the linear lens part 510. The upper electrodes 177 and 179 may be provided to be parallel to the lower electrodes 175 and 179, respectively.

Further, the first and second lens electrodes 193a and 197b may be provided at a predetermined angle in the plan view. In addition, the first and second lens electrodes 193a and 197b may be provided to be parallel to each other.

According to an exemplary embodiment of the invention, there may be a gap between the first lens electrode 193a and the second lens electrode 197b. Further, there may be the gap between the lower electrode 175 and the upper electrode 177. Because of the gap, a duty (a width of the electrode left after the etching divided by a width of the electrode etched when the etching is performed) may be controlled to be smaller than about 0.5 when each of the electrodes is etched.

While this invention has been described in connection with what is presently considered to be practical exemplary embodiments, it is to be understood that the invention is not limited to the disclosed exemplary embodiments, but, on the contrary, is intended to cover various modifications and equivalent arrangements included within the spirit and scope of the appended claims.

What is claimed is:

1. A method of manufacturing a display device, the method comprising:
forming a first signal line and a second signal line on a first substrate;
forming a first insulating layer which covers the first signal line and the second signal line;
forming a first electrode layer on the first insulating layer;
forming a first electrode piece and a first lens electrode from the first electrode layer based on a first mask;
forming a second insulating layer on the first electrode piece and the first lens electrode;
defining a first contact hole exposing the first signal line in the first insulating layer, the second insulating layer and the first electrode piece based on a second mask, and defining a second contact hole exposing the second signal line in the first insulating layer and the second insulating layer based on the second mask;
forming a second electrode layer on the second insulating layer while covering the first signal line and the second signal line;
forming a lower electrode from the second electrode layer based on the first mask;
forming a third electrode layer on the second insulating layer while covering the lower electrode and the second signal line; and
forming an upper electrode and a second lens electrode from the third electrode layer based on the first mask.

2. The method of claim 1, wherein:
the first lens electrode, the second lens electrode, the lower electrode and the upper electrode include a transparent conductor.

3. The method of claim 1, further comprising:
forming an intermediate electrode from the first electrode piece based on the second mask during the defining the first contact hole.

4. The method of claim 3, wherein:
the intermediate electrode comprises an part which is exposed by the second insulating layer.

5. The method of claim 4, wherein:
the lower electrode side-contacts the exposed part of the intermediate electrode and the first signal line.

6. The method of claim 1, wherein:
the lower electrode and the upper electrode are separated from each other in a plan view.

7. The method of claim 6, wherein:
the first lens electrode and the second lens electrode are separated in the plan view.

8. The method of claim 7, wherein:
a gap is defined between the upper electrode and the lower electrode.

9. The method of claim 8, wherein:
a gap is defined between the first lens electrode and the second lens electrode.

10. The method of claim 1, wherein:
the forming the first electrode piece and the first lens electrode from the first electrode layer based on the first mask comprises:
forming a first photosensitive film on the first electrode layer and forming a first photosensitive film pattern by etching the first photosensitive film by using the first mask; and
forming the first electrode piece and the first lens electrode by etching the first electrode layer by using the first photosensitive film pattern as a mask.

11. The method of claim 10, wherein:
the defining the first contact hole exposing the first signal line in the first insulating layer, the second insulating layer and the first electrode piece based on the second mask and the defining the second contact hole exposing the second signal line in the first insulating layer and the second insulating layer based on the second mask comprises:
forming a second photosensitive film on the second insulating layer and forming a second photosensitive film pattern by etching the second photosensitive film by using the second mask; and
defining the first contact hole exposing the first signal line and defining the second contact hole exposing the second signal line by etching the second insulating layer, the first electrode piece and the first insulating layer by using the second photosensitive film pattern as a mask.

12. The method claim 11, wherein:
the forming the lower electrode from the second electrode layer based on the first mask comprises:
forming a third photosensitive film on the second electrode layer;
forming a third photosensitive film pattern by etching the third photosensitive film by using the first mask; and
forming the lower electrode by etching the second electrode layer by using the third photosensitive film pattern as a mask.

13. The method of claim 12, wherein:
the forming the upper electrode and the second lens electrode from the third electrode layer based on the first mask comprises:
forming a fourth photosensitive film on the third electrode layer and forming a fourth photosensitive film pattern by etching the fourth photosensitive film by using the first mask; and
forming the upper electrode and the second lens electrode by etching the third electrode layer by using the fourth photosensitive film pattern as a mask.

14. The method of claim 13, wherein:
the first, second and third photosensitive films include one of a positive photoresist material and a negative photoresist material, and the fourth photosensitive film includes the other of the positive photoresist material and the negative photoresist material.

15. The method of claim 14, wherein:
parts of the first, second, and third photosensitive films which receive light are etched and a part of the fourth photosensitive film which does not receive light is etched.

16. The method of claim 13, wherein:
when the first, second, and third electrode layers are etched, a value of a width of the electrode left after the etching divided by a width of the electrode before the etching is smaller than about 0.5.

17. A display device comprising:
a driver configured to provide a voltage;
a display panel configured to display an image; and
a lens part which is configured to allow the image of the display panel to be recognized as a two-dimensional image or a three-dimensional image and comprises a linear lens part comprising;
a first substrate,
a first insulating layer disposed on the first substrate,
a first lens electrode disposed on the first insulating layer,
a second insulating layer formed to cover the first lens electrode, and
a second lens electrode disposed on the second insulating layer, and
a pad which is configured to supply the voltage provided by the driver to the linear lens part and comprises:
a first signal line disposed on the first substrate,
a second signal line disposed on the first substrate to be adjacent and parallel to the first signal line,
an intermediate electrode disposed on the first signal line and the first substrate,
a lower electrode which contacts the first signal line and the intermediate electrode, and
an upper electrode which contacts the second signal line.

18. The display device of claim 17, wherein:
the first lens electrode, the second lens electrode, the intermediate electrode, the lower electrode and the upper electrode include a transparent conductor.

19. The display device of claim 18, wherein:
the lens part further comprises a second insulating layer which is disposed on the first insulating layer and covers the intermediate electrode,
the intermediate electrode comprises a part which is exposed by the second insulating layer,
a first contact hole exposing the first signal line is defined in the first insulating layer, the exposed part of the intermediate electrode and the second insulating layer, and
a second contact hole exposing the second signal line is defined in the first insulating layer and the second insulating layer.

20. The display device of claim 19, wherein:
the lower electrode side-contacts the exposed part of the intermediate electrode and the first signal line.
